(19) United States
(12) Patent Application Publication
(10) Pub. No.: US 2026/0231075 A1
(43) Pub. Date: Aug. 6, 2026

(54) PERSONAL INTERNET OF THINGS NETWORK (PIN) ELEMENT REGISTRATION METHOD AND COMMUNICATION APPARATUS

(71) Applicant: BEIJING XIAOMI MOBILE SOFTWARE CO., LTD., Beijing (CN)

(72) Inventor: Jianning LIU, Beijing (CN)

(73) Assignee: BEIJING XIAOMI MOBILE SOFTWARE CO., LTD., Beijing (CN)

(21) Appl. No.: 19/146,270

(22) PCT Filed: Jan. 9, 2023
(86) PCT No.: PCT/CN2023/071453

§ 371 Date: Jul. 8, 2025

(51) Int. Cl. H04W 60/00

(52) U.S. Cl. CPC H04W 60/00

(57) ABSTRACT

A method for registering a personal internet of things network (PIN) element (PINE), performed by a terminal, is provided, and the method includes: sending a registration request to an access network device, wherein the registration request comprises PIN information of the terminal.

### CROSS-REFERENCE TO RELATED APPLICATION

The present application is a U.S. national phase of International Application No. PCT/CN2023/071453, filed on Jan. 9, 2023, the content of which is incorporated herein by reference in its entirety.

### TECHNICAL FIELD

The disclosure relates to the field of communication technologies, and in particular, to a method for registering a personal internet of things network (PIN) element (PINE) and a communication apparatus.

### BACKGROUND

A personal internet of things network (PIN) consists of PIN elements (PINEs) that communicate using PIN direct connection or direct network connection. In related arts, a terminal can register with a PIN server to subscribe to a PIN service, and register, after subscription, with a core network based on a role of the terminal in the PIN.

### SUMMARY

According to a first aspect of embodiments of the disclosure, a method for registering a PINE is provided, which is performed by a terminal and includes:
sending a registration request to an access network device, in which the registration request comprises PIN information of the terminal.

According to a second aspect of embodiments of the disclosure, a method for registering a PINE is provided, which is performed by an access network device and includes:
receiving a first registration request sent by a terminal, in which the first registration request comprises PIN information of the terminal; and
sending a second registration request to an access and mobility management function (AMF) network element, wherein the second registration request comprises the PIN information of the terminal.

According to a third aspect of embodiments of the disclosure, a method for registering a PINE is provided, which is performed by an AMF network element and includes:
receiving a registration request sent by an access network device, and/or receiving subscription data associated with a terminal sent by a unified data management (UDM) network element, wherein the registration request comprises PIN information of the terminal; and

According to a fourth aspect of embodiments of the disclosure, a communication apparatus is provided and includes a processor and a memory storing a computer program. The processor executes the computer program stored in the memory to enable the communication apparatus to execute the method in the first aspect.

According to a fifth aspect of embodiments of the disclosure, a communication apparatus is provided and includes a processor and a memory storing a computer program. The processor executes the computer program stored in the memory to enable the communication apparatus to execute the method in the second aspect.

According to a sixth aspect of embodiments of the disclosure, a communication apparatus is provided and includes a processor and a memory storing a computer program. The processor executes the computer program stored in the memory to enable the communication apparatus to execute the method in the third aspect.

According to a seventh aspect of embodiments of the disclosure, a non-transitory computer-readable storage medium is provided and configured to store instructions for use by the above communication apparatus. When the instructions are executed, the communication apparatus is enabled to execute the method in the first aspect.

According to an eighth aspect of embodiments of the disclosure, a non-transitory computer-readable storage medium is provided and configured to store instructions for use by the above communication apparatus. When the instructions are executed, the communication apparatus is enabled to execute the method in the second aspect.

According to a ninth aspect of embodiments of the disclosure, a non-transitory computer-readable storage medium is provided and configured to store instructions for use by the above communication apparatus. When the instructions are executed, the communication apparatus is enabled to execute the method in the third aspect.

### BRIEF DESCRIPTION OF THE DRAWINGS

In order to more clearly illustrate the technical solutions in the embodiments of the disclosure or in the background, the accompanying drawings to be used in the embodiments of the disclosure or the background art will be described below.

FIG. 1 is a schematic diagram of a communication system according to an embodiment of the disclosure.

FIG. 2 is a schematic diagram of an authorization and management process for a PIN and a PINE according to an embodiment of the disclosure.

FIG. 3 is a schematic diagram of a registration process of a PINE with gateway capability (PEGC) to a core network according to an embodiment of the disclosure.

FIG. 4 is a schematic flowchart of a method for registering a PINE according to a embodiment of the disclosure.

FIG. 5 is a schematic flowchart of a method for registering a PINE according to another embodiment of the disclosure.

FIG. 6 is a schematic flowchart of a method for registering a PINE according to further another embodiment of the disclosure.

FIG. 7 is a schematic flowchart of a method for registering a PINE according to yet another embodiment of the disclosure.

FIG. 8 is a schematic flowchart of a method for registering a PINE according to yet another embodiment of the disclosure.

FIG. 9 is schematic flowchart of a method for registering a PINE according to yet another embodiment of the disclosure.

FIG. 10 is schematic flowchart of a method for registering a PINE according to yet another embodiment of the disclosure.

FIG. 11 is schematic flowchart of a method for registering a PINE according to yet another embodiment of the disclosure.

FIG. 12 is schematic flowchart of a method for registering a PINE according to yet another embodiment of the disclosure.

FIG. 13 is an interaction schematic diagram of a method for registering a PINE according to an embodiment of the disclosure.

FIG. 14 is a schematic diagram of a communication apparatus according to an embodiment of the disclosure.

FIG. 15 is a schematic diagram of a communication apparatus according to another embodiment of the disclosure.

FIG. 16 is a schematic diagram of a chip according to an embodiment of the application.

### DETAILED DESCRIPTION

To better understand a method and apparatus for registering a PINE disclosed in the embodiments of the disclosure, a communication system applicable to the embodiments of the disclosure is first described below.

It should be noted that “including” in the disclosure may refer to direct inclusion or indirect indication. For example, if A includes B, it may mean that B is directly included in A, or certain information in A may indirectly indicate B. The disclosure does not limit this.

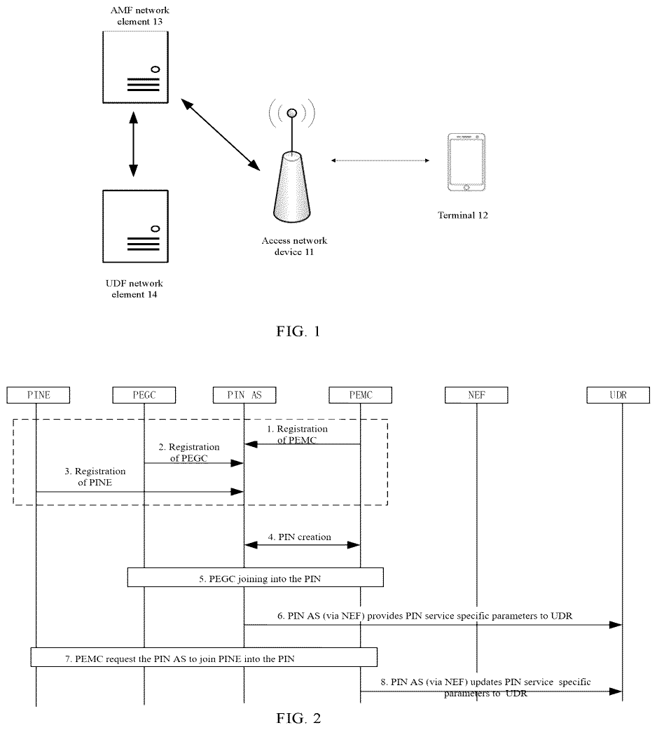

FIG. 1 is a schematic diagram of a communication system according to an embodiment of the disclosure. The communication system may include, but is not limited to, one access network device, one or more core network devices, and one terminal. The number and form of devices shown in FIG. 1 are only for illustration and do not constitute a limitation to the embodiments of the disclosure. In practical applications, there may be two or more access network devices and two or more terminals. The communication system shown in FIG. 1 takes one access network device 11, one terminal 12, and two core network devices, namely an AMF network element 13 and a UDM 14, as an example.

It should be noted that the technical solutions of the embodiments of the disclosure may be applied to various communication systems, such as a long term evolution (LTE) system, a 5th generation (5G) mobile communication system, a 5G new radio (NR) system, or other future new mobile communication systems.

The access network device 11 in the embodiments of the disclosure is an entity on an access network side used for transmitting or receiving signals. For example, the access network device 11 may be an evolved nodeB (eNB), a transmission reception point (TRP), a next generation nodeB (gNB) in an NR system, a base station in other future mobile communication systems, or an access node in a wireless fidelity (WiFi) system. The specific technology and specific device form adopted by the access network device are not limited in the embodiments of the disclosure. The access network device provided in the embodiments of the disclosure may be composed of a central unit (CU) and a distributed unit (DU). The CU may also be referred to as a control unit. Adopting a CU-DU structure may split protocol layers of the access network device (e.g., a base station), where functions of some protocol layers are centrally controlled in the CU, and functions of the remaining part or all protocol layers are distributed in the DU, which is centrally controlled by the CU.

The terminal in the embodiments of the disclosure is an entity on a user side used for receiving or transmitting signals and having internet of things (IOT) functions, such as a mobile phone, a wearable device, a smart home device, a smart office device, etc. The terminal may also be referred to as a terminal, a user equipment (UE), a mobile station (MS), a mobile terminal (MT), etc. The terminal may be a car with communication functions, a smart car, a mobile phone, a wearable device, a Pad, a computer with a wireless transceiving function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. The specific technology and specific device form adopted by the terminal are not limited in the embodiments of the disclosure.

The AMF network element 13 in the embodiments of the disclosure is a logical node functional network element on a core network side. The AMF network element 13 serves as a core network control plane access point for the terminal and a wireless network, receives all connection and session-related information from the terminal, and executes registration, connection, reachability, and mobility management. The UDM network element 14 is a network element on the core network side used for data storage and management, responsible for managements of user identifiers, subscription data, and authentication data, as well as a registration management of a service network element (such as the AMF) of a user.

The disclosure does not limit the names of the AMF network element and UDM network element. On the basis of having functions of the AMF network element or the UDM network element, the names of the AMF network element and UDM network element may be arbitrarily adjusted as needed.

It may be understood that the communication system in the embodiments of the disclosure is intended to more clearly illustrate the technical solutions of the embodiments of the disclosure, and does not constitute a limitation to the technical solutions provided by the embodiments of the disclosure. Those of ordinary skill in the art know that with an evolution of system architecture and an emergence of new service scenarios, the technical solutions provided by the embodiments of the disclosure are also applicable to similar technical problems.

FIG. 2 is a schematic diagram of an authorization and management process for a PIN and a PINE according to an embodiment of the disclosure.

As shown in FIG. 2, assuming that the PINE is able to communicate with a PIN application server (PIN AS) via an internet, steps 1, 2, and 3 shown in dashed boxes of FIG. 2 are the processes for each PINE, such as a PINE, a PEGC, and a PINE with gateway capability (PEGC), to register with the PIN AS. The processes include an authentication and an authorization of the PINE, as well as reporting a PINE identify document (ID) and a PINE profile to the PIN AS.

At step 4: a PIN is created.

After the registering is successful, the PEMC may send a request for creating a PIN to the PIN AS to create the PIN, in which a PIN ID may be assigned to the PEMC by the PIN AS.

At step 5: the PEGC joins the PIN.

The PEMC may request the PIN AS to add the PEGC into the PIN. In a case where the PEGC accepts this invitation, the PIN AS updates the PIN profile and context data, and the PIN AS sends configurations and parameters to the PEGC for PIN communication.

At step 6: the PIN AS provides PIN service specific parameters to a unified data repository (UDR) functional network element for a policy control of the PEGC. For example, the PIN ID, a default quality of service (QOS) requirement, and a valid duration for PIN communication, etc. may be provided.

In some embodiments, the PIN AS may provide the PIN service specific parameters to the UDR via a network exposure function (NEF) network element.

At step 7: the PEMC requests the PIN AS to add the PINE into the PIN.

This includes communication requirements of the PINE, such as the associated PEGC, whether the PINE is authorized to access a network system via the PEGC, and the QoS requirement. In a case where the PIN accepts this invitation, the PIN AS updates the PIN profile and the context data. The PIN AS sends configurations and parameters to the PINE and the PEGC for PIN communication.

At step 8: the PIN AS updates the PIN service specific parameters to the UDR (via the NEF).

This is used for an association between the PINE and the PEGC. For example, a PINE ID, a default QoS requirement, a valid duration for the PINE to communicate with the communication system, etc. may be provided.

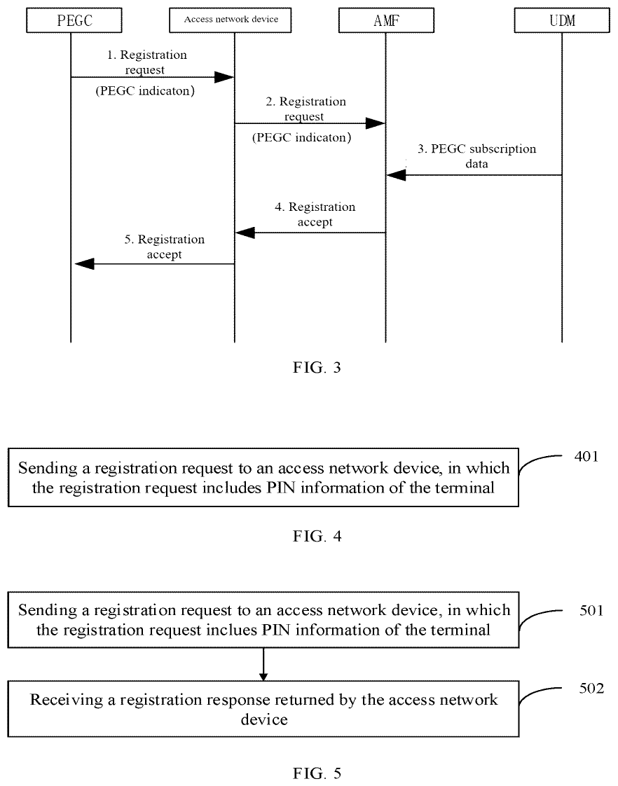

After the PINE completes the registering with the PIN AS via the method shown in FIG. 2, the PEGC terminal in the PIN may register with a core network. FIG. 3 is a schematic diagram of a registration process of a PEGC to a core network according to an embodiment of the disclosure. As shown in FIG. 3, the registration process includes:

1. The PEGC sends a registration request to an access network device.

This request indicates that the terminal is a PINE with a network management function.

In some embodiments, the access network device may be an eNB, a gNB, etc., and the disclosure does not limit this

The access network device sends the registration request to an AMF.

The AMF obtains subscription data of the PEGC terminal from a UDM.

In some embodiments, the subscription data may include information such as a maximum number of PINE/PIN allowed, a PIN duration, and allowed services.

In a case where the subscription data allows the terminal to act as a PEGC, the AMF returns a registration accept message to the access network device.

In some embodiments, the registration accept message may include PIN service specific parameters, such as the PIN duration, the allowed services, etc.

The access network device returns a registration accept message to the terminal.

In some embodiments, in a case where the subscription data does not allow the terminal to act as a PEGC, the AMF returns a registration rejection message to the access network device.

In some embodiments, the registration rejection message may also include information such as a reason for rejection.

In other words, after the terminal completes the registering with the PIN AS and knows its own role in the PIN, the terminal may register with the core network via the above process.

The disclosure proposes a method for registering a PINE with a core network. In a case where a terminal has subscribed to a PIN service or not, and does not know its role in a PIN, the terminal may also use the method provided by the disclosure to register with the core network.

a method and an apparatus for registering a PINE provided by the disclosure are described in detail below in conjunction with the drawings.

It should be noted that following embodiments of the disclosure and optional embodiments in each embodiment may, when there is no conflict, be combined with each other to implement a process of registering the PINE. When embodiments are combined with each other, the order between each step may be changed when there is no conflict.

FIG. 4 is a schematic flowchart of a method for registering a PINE provided by an embodiment of the disclosure, and the method is executed by a terminal. As shown in FIG. 4, the method may include but is not limited to the following steps.

At step 401: a registration request is sent to an access network device, in which where the registration request includes PIN information of the terminal.

In the disclosure, the terminal may be a PINE, a PEGC, or a PEMC, and the disclosure does not limit this.

In some embodiments, when the terminal sends the registration request, the terminal does not know its role in the PIN. That is to say, the terminal does not know whether it acts as a PEGC or a PEMC in the PIN, or may act as both.

In some possible implementations, the terminal may have subscribed to a PIN service or not when sending the registration request, and the disclosure does not limit this.

In some possible implementations, the PIN information includes at least one of: a PIN capability indication, a PEMC indication, or a PEGC indication.

In some embodiments, the PIN capability indication indicates whether the terminal supports a PIN capability.

In some embodiments, the PIN information may directly include the PIN capability indication. For example, a specific bit in the PIN information indicates the PIN capability of the terminal. When the specific bit takes a first value, it indicates that the terminal supports the PIN capability. When the specific bit takes a second value, it indicates that the terminal does not support the PIN capability. The first value and the second value may be any different values, which are not limited in the disclosure.

In some embodiments, the PIN information may not directly include the PIN capability indication, but indirectly indicate the PIN capability indication via other information. For example, the PIN information includes the PEGC indication, and the PEGC indication indicates that the terminal has a PEGC capability, which indirectly indicates that the terminal supports the PIN capability, etc., which are not limited in the disclosure.

In some embodiments, the PEMC indication indicates whether the terminal has a PEMC capability.

In some possible implementation, the PIN information may directly include the PEMC indication. For example, a specific bit in the PIN information characterizes the PEMC indication. When the specific bit takes a third value, it characterizes that the terminal supports the PEMC capability. When the specific bit takes a fourth value, it indicates that the terminal does not support the PEMC capability. The third value and the fourth value may be any different values, which are not limited in the disclosure. Alternatively, the PIN information may not directly include the PEMC indication, but indirectly indicate the PEMC indication via other information.

In some embodiments, the PEGC indication indicates whether the terminal has a PEGC capability.

In some possible implementations, the PIN information may directly include the PEGC indication. For example, a specific bit in the PIN information characterizes the PEGC indication. When the specific bit takes a fifth value, it characterizes that the terminal supports the PEGC capability. When the specific bit takes a sixth value, it indicates that the terminal does not support the PEGC capability. The fifth value and the sixth value may be any different values, which are not limited in the disclosure. Alternatively, the PIN information may not directly include the PEGC indication, but indirectly indicate the PEGC indication via other information.

In some possible implementations, the above first value, second value, third value, fourth value, fifth value, and sixth value may all be different, or may include a same value. For example, the first value, third value, and fifth value are the same, and the second value, fourth value, and sixth value are the same; or the first value, fourth value, and fifth value are the same, and the second value, third value, and sixth value are the same, etc., which are not limited in the disclosure. The above values may be configured by the access network device, pre-configured, or agreed upon by a protocol, which are not limited in the disclosure.

This embodiment may be arbitrarily combined with other embodiments without conflict, and may be combined with optional embodiments in other embodiments. The order of steps in the combination may be exchanged without conflict. The optional embodiments in this embodiment may also be arbitrarily combined with other embodiments of the disclosure or with the optional embodiments in other embodiments without conflict.

In the embodiments of the disclosure, the terminal may complete the registering with the core network by sending the registration request including the PIN information to the access network device. The registration process does not require the terminal to know its role in the PIN, which improves a registration efficiency and saves a registration time.

FIG. 5 is a schematic flowchart of a method for registering a PINE provided by another embodiment of the disclosure, and the method is executed by a terminal. As shown in FIG. 5, the method may include but is not limited to the following steps.

At step 501: a registration request is sent to an access network device, in which where the registration request includes PIN information of the terminal.

In some embodiments, the PIN information includes at least one of: a PIN capability indication, a PEMC indication, or a PEGC indication.

For the specific implementation of the above step 501, reference may be made to the detailed description of any embodiment of the disclosure, which will not be repeated here.

At step 502: a registration response returned by the access network device is received.

In some possible implementations, the registration response is generated by an AMF and sent to the terminal via the access network device, which may indicates to the terminal whether a core network accepts the registration request of the terminal.

In some possible implementations, the registration response includes at least one of: a PIN service supported indication, a PEMC allowed indication, or a PEGC allowed indication. The PIN service supported indication may be indicate that the network supports a PIN service.

In some embodiments, in a case where the AMF accepts the registration request of the terminal, the registration response may include at least one of: the PIN service supported indication, the PEMC allowed indication, or the PEGC allowed indication.

In some embodiments, the registration response may include indication directly indicating whether the AMF accepts the registration request of the terminal.

Alternatively, the registration response may also indirectly indicate whether the AMF accepts the registration request of the terminal via information contained therein. Therefore, after receiving the registration response, in a case where the registration response includes at least one of the above indications, the terminal may determine that the sent registration request is accepted by the core network. Conversely, the terminal may determine that the sent registration request is rejected by the core network.

In some embodiments, the registration response may directly include the PIN service supported indication. For example, when a specific bit in the registration response takes a first specific value, it indicates that the network supports the PIN service. Correspondingly, when the specific bit takes a non-first specific value, it indicates that the network does not support the PIN service.

In some embodiments, the registration response may not directly include the PIN service supported indication, but indirectly indicate the PIN service supported indication via other information, which is not limited in the disclosure.

In some possible implementations, the PEMC allowed indication indicates that subscription information of the terminal allows the terminal to act as a role of PEMC in the PIN.

In some embodiments, the registration response may directly include the PEMC allowed indication. For example, when a specific bit in the registration response takes a second specific value, it indicates that the subscription information allows the terminal to act as the role of PEMC. Correspondingly, when the specific bit takes a non-second specific value, it indicates that the subscription information does not allow the terminal to act as the role of PEMC. Alternatively, the registration response may not directly include the PEMC allowed indication, but indirectly indicate the PEMC allowed indication via other information, which is not limited in the disclosure.

In some possible implementations, the PEGC allowed indication indicates that the subscription information of the terminal allows the terminal to act as a role of PEGC in the PIN.

In some embodiments, the registration response may directly include the PEGC allowed indication. For example, when a specific bit in the registration response takes a third specific value, it indicates that the subscription information allows the terminal to act as the role of PEGC. When the specific bit takes a non-third specific value, it indicates that the terminal is not allowed to act as the role of PEGC. Alternatively, the registration response may not directly include the PEGC allowed indication, but indirectly indicate the PEGC allowed indication via other information, which is not limited in the disclosure.

In some possible implementations, when the registration request of the terminal is not accepted, the registration response may include at least one of an indication of not supporting the PIN service, a PEMC non-allowed indication, and a PEGC non-allowed indication, or may also include other indication information, such as a reason for rejection, etc., which are not limited in the disclosure.

In some possible implementations, the above specific bits may be the same bit in the registration response or different bits in the registration response, which is not limited in the disclosure.

This embodiment or any step in this embodiment may be arbitrarily combined with other embodiments without conflict, and may be combined with optional embodiments in other embodiments. The order of steps in the combination may be exchanged without conflict. The optional embodiments in this embodiment may also be arbitrarily combined with other embodiments of the disclosure or with the optional embodiments in other embodiments without conflict.

In the embodiments of the disclosure, the terminal may request a registration with the core network by sending the registration request including the PIN information to the access network device, and determine whether the network accepts the registration request according to the registration response returned by the received access network device. The terminal may not only register with the core network without knowing its role in the PIN, but also determine whether its registration request is accepted, and the registration process is simple.

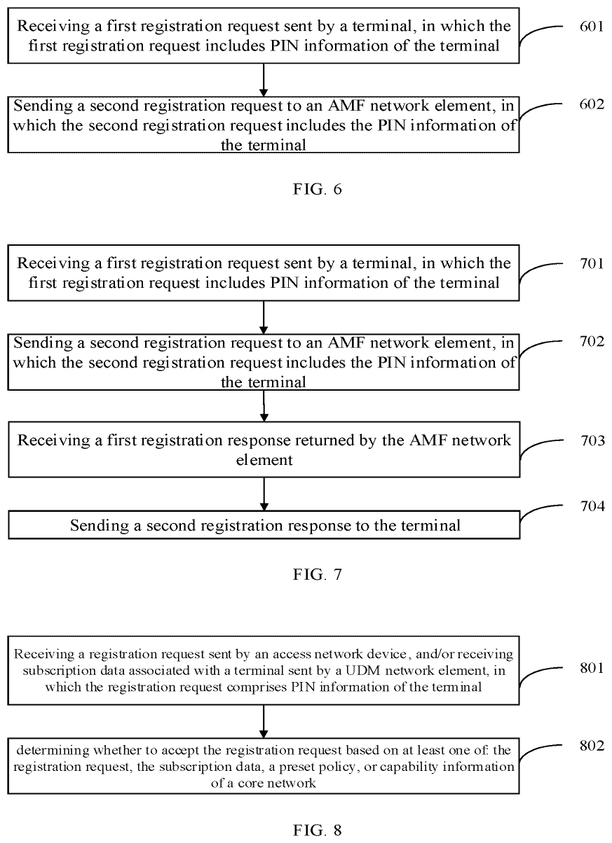

FIG. 6 is a schematic flowchart of a method for registering a PINE according to another embodiment of the disclosure. The method is executed by an access network device. As shown in FIG. 6, the method may include, but is not limited to, the following steps.

At step 601: a first registration request sent by a terminal is recevied, in which the first registration request includes PIN information of the terminal.

In some embodiments, the PIN information includes at least one of: a PIN capability indication, a PEMC indication, or a PEGC indication.

For the implementable forms of the above-mentioned registration request and PIN information, reference may be made to the detailed descriptions of any embodiment in the disclosure, and details are not repeated herein.

At step 602: a second registration request is sent to an AMF network element, in which the second registration request includes the PIN information of the terminal.

In some embodiments, the second registration request may further include an identity (ID) of the access network device.

After receiving the first registration request sent by the terminal, the access network device may send the second registration request to the AMF network element on the core network side based on the first registration request, so as to send the PIN information in the first registration request to the AMF network element.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the embodiments of the disclosure, after receiving the registration request sent by the terminal, the access network device may forward the registration request to the core network device, thereby implementing the registration of the terminal with the core network. The registration process is simple, and resources of the access network device occupied are low.

FIG. 7 is a schematic flowchart of a method for registering a PINE according to another embodiment of the disclosure. The method is executed by an access network device. As shown in FIG. 7, the method may include, but is not limited to, the following steps.

At step 701: a first registration request sent by a terminal is received, in which the first registration request includes PIN information of the terminal.

At step 702: a second registration request is sent to an AMF network element, in which the second registration request includes the PIN information of the terminal.

In some embodiments, the PIN information includes at least one of: a PIN capability indication, a PEMC indication, or a PEGC indication.

For the specific implementable forms of the above steps 701 to 702 and the PIN information, reference may be made to the detailed descriptions of other embodiments in the disclosure, and details are not repeated herein.

At step 703: a first registration response returned by the AMF network element is received.

At step 704: a second registration response is sent to the terminal.

In some embodiments, the first registration response and the second registration response are respectively used to indicate whether the AMF accepts the registration request of the terminal.

In some embodiments, each of the first registration response and the second registration response may include indication information that directly indicates whether the AMF accepts the registration request of the terminal, or each of the first registration response and the second registration response may indirectly indicate whether the AMF accepts the registration request of the terminal via information contained therein.

In some embodiments, in a case where the registration request is accepted, each of the first registration response and the second registration response include at least one of: a PIN service supported indication, a PEMC allowed indication, or a PEGC allowed indication.

For the implementable forms of the registration response, reference may be made to the detailed descriptions of other embodiments in the disclosure, and details are not repeated herein.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the embodiment of the disclosure, the access network device only needs to forward the registration request and the registration response during the registration process of the terminal. Resources of the access network device occupied are few, and the registration process is fast and efficient.

FIG. 8 is a schematic flowchart of a method for registering a PINE element according to another embodiment of the disclosure. The method is executed by an AMF network element. As shown in FIG. 8, the method may include, but is not limited to, the following steps.

At step 801: a registration request sent by an access network device is received and/or subscription data associated with a terminal sent by a UDM network element is received, in which the registration request includes PIN information of the terminal.

In some possible implementations, the registration request is sent by the terminal to the access network device and forwarded by the access network device to the AMF.

In some embodiments, the PIN information includes at least one of: a PIN capability indication, a PEMC indication, or a PEGC indication.

For the specific implementations of the PIN information, reference may be made to the detailed descriptions of other embodiments in the disclosure, and details are not repeated herein.

In some possible implementations, in a case where the terminal has subscribed to a PIN, the AMF may obtain the subscription data of the terminal from the UDM. The subscription data may include at least one of: a PEMC allowed indication and a PEGC allowed indication.

For the meanings of the PEMC allowed indication and the PEGC allowed indication, reference may be made to the detailed descriptions of other embodiments in the disclosure, and details are not repeated herein.

In some possible implementations, in a case where the terminal does not subscribe to the PIN, the AMF will not obtain the subscription data of the terminal from the UDM.

At Step 802: whether to accept the registration request is determined based on at least one of: the registration request, the subscription data, a preset policy, or capability information of a core network.

In some embodiments, the preset policy is a policy agreed upon based on a protocol or a policy preconfigured in the AMF. The preset policy may include information such as whether a region where the terminal is currently registered allows the PIN service. The capability information of the core network may include information such as whether the core network has a capability to support the PIN service.

In some possible implementations, after receiving the registration request and/or the subscription data associated with the terminal, the AMF may determine whether to accept the registration request according to one or more of the registration request, the subscription data, the preset policy, and the capability information of the core network.

For example, in a case where the AMF does not receive the subscription data but has a preset policy and capability information of the core network locally, the AMF may determine whether to accept the registration request according to the registration request, the preset policy, and the capability information of the core network; or, in a case where the AMF does not receive the subscription data and does not have the preset policy locally but has the capability information of the core network, the AMF may determine whether to accept the registration request according to the registration request and the capability information of the core network.

In some possible implementations, in a case where the registration request indicates that the terminal has a PEMC capability, the subscription data allows the terminal to act as a role of PEMC in the PIN, the preset policy indicates that the region where the terminal is currently registered allows the PIN service, and the capability information of the core network indicates that the network supports the PIN service, the AMF may determine to accept the registration request.

In some possible implementations, in a case where the registration request indicates that the terminal has the PEMC capability but the subscription data does not allow the terminal to act as a role of PEMC in the PIN, the AMF may determine not to accept the registration request.

In some possible implementations, in a case where the registration request includes the PIN capability indication but the capability information of the core network indicates that the core network does not support the PIN service, the AMF may determine not to accept the registration request, and so on.

It should be noted that the foregoing implementations are merely schematic illustrations of the process in which the AMF determines whether to accept the registration request based on at least one of the registration request, the subscription data, the preset policy, or the capability information of the core network, and should not be construed as restrictive descriptions of determining, by the AMF, whether to accept the registration request.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the embodiments of the disclosure, after receiving the registration request sent by the access network device and/or the subscription data sent by the UDM, the AMF may determine whether to accept the registration request based on at least one of the registration request, the subscription data, the preset policy, or the capability information of the core network. During this registration process, the AMF does not need the terminal to report the role of the terminal in the PIN, and the registration process is simple.

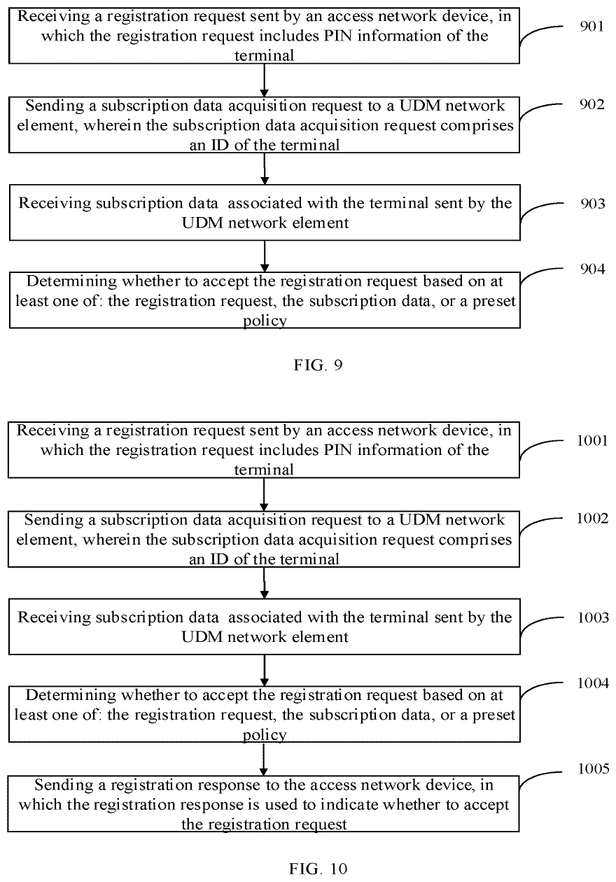

FIG. 9 is a schematic flowchart of a method for registering a PINE according to another embodiment of the disclosure. The method is executed by an AMF network element. As shown in FIG. 9, the method may include, but is not limited to, the following steps.

At step 901: a registration request sent by an access network device is received, in which the registration request includes the PIN information of the terminal.

In some embodiments, the PIN information includes at least one of: a PIN capability indication, a PEMC indication, or a PEGC indication.

For the specific implementations of the above step 901 and the PIN information, reference may be made to the detailed descriptions of other embodiments in the disclosure, and details are not repeated herein.

At step 902: a subscription data acquisition request is sent to a UDM network element, in which the subscription data acquisition request includes an ID of the terminal.

At step 903: subscription data associated with the terminal sent by the UDM network element is received.

In some possible implementations, in a case where the terminal has subscribe to a PIN, the AMF may obtain the subscription data of the terminal from the UDM. The subscription data may include at least one of the following: a PEMC allowed indication or a PEGC allowed indication.

For the meanings of the PEMC allowed indication and the PEGC allowed indication, reference may be made to the detailed descriptions of other embodiments in the disclosure, and details are not repeated herein.

In some possible implementations, in a case where the terminal does not subscribe to the PIN, the AMF will not obtain the subscription data of the terminal from the UDM.

At step 904: whether to accept the registration request is determined based on at least one of: the registration request, the subscription data, a preset policy, or capability information of a core network.

For the specific implementation form of the above step 904, reference may be made to the detailed descriptions of other embodiments in the disclosure, and details are not repeated herein.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the disclosure, after receiving the registration request of the terminal forwarded by the access network device, the AMF may send the subscription data acquisition request to the UDM, and after acquiring the subscription data associated with the terminal, determine whether to accept the registration request based on at least one of the registration request, the subscription data, the preset policy, or the capability information of the core network. During this registration process, only a small amount of resources of the AMF need to be occupied, and the registration process is simple.

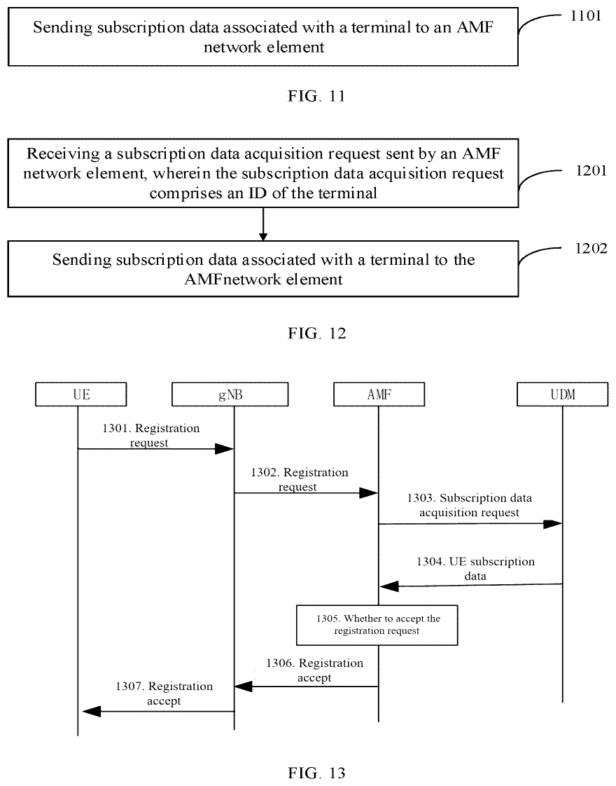

FIG. 10 is a schematic flowchart of a method for registering a PINE according to another embodiment of the disclosure. This method is executed by an AMF. As shown in FIG. 10, the method may include, but is not limited to, the following steps.

At step 1001: a registration request sent by an access network device is received, in which the registration request includes the PIN information of the terminal.

In some embodiments, the PIN information includes at least one of: a PIN capability indication, a PEMC indication, or a PEGC indication.

At step 1002: a subscription data acquisition request is sent to a UDM network element, in which the subscription data acquisition request includes an ID of the terminal.

At step 1003: subscription data associated with the terminal sent by the UDM network element is received

In some possible implementations, in a case where the terminal has subscribe to a PIN, the AMF may obtain the subscription data of the terminal from the UDM. The subscription data may include at least one of: a PEMC allowed indication and a PEGC allowed indication.

For the meanings of the PEMC allowed indication and the PEGC allowed indication, reference may be made to the detailed descriptions of other embodiments in the disclosure, and details are not repeated herein.

In some possible implementations, in a case where the terminal does not subscribe to the PIN, the AMF will not obtain the subscription data of the terminal from the UDM.

At step 1004: whether to accept the registration request is determined based on at least one of: the registration request, the subscription data, a preset policy, or capability information of a core network.

For the specific implementation forms of the above steps 1001 to 1004, reference may be made to the detailed descriptions of any embodiment in the disclosure, and details are not repeated herein.

At step 1005: a registration response is sent to the access network device.

In some possible implementations, after determining whether to accept the registration request, the AMF may also send the registration response to the access network device to synchronize a processing result of the registration request to the terminal.

In some embodiments, the registration response may include indication information that directly indicates whether the AMF accepts the registration request of the terminal, or the registration response may indirectly indicate whether the AMF accepts the registration request of the terminal via information contained therein.

In some embodiments, in a case where the AMF determines to accept the registration request, the registration response includes at least one of: a PEMC allowed indication and a PEGC allowed indication.

In some embodiments, the capability information of the core network indicates that the core network has a capability to support a PIN service, the registration response further includes a PIN service supported indication.

For the meanings and implementable forms of the above-mentioned PEMC allowed indication, PEGC allowed indication, and PIN service supported indication, reference may be made to the detailed descriptions of other embodiments in the disclosure, and details are not repeated herein.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the embodiment of the disclosure, after receiving the registration request of the terminal forwarded by the access network device, the AMF may send the subscription data acquisition request to the UDM. After acquiring the subscription data associated with the terminal, the AMF may determine whether to accept the registration request based on at least one of the registration request, the subscription data, the preset policy, and the capability information of the core network, and send the registration response to the access network device to synchronize the result of the registration request to the terminal. This registration process may be implemented without the terminal reporting its role in the PIN, occupying few resources, and the registration processa is simple.

FIG. 11 is a schematic flowchart of a method for registering a PINE according to another embodiment of the disclosure. This method is executed by a UDM network element. As shown in FIG. 11, the method may include, but is not limited to, the following steps.

At step 1101: subscription data associated with a terminal is sent to an AMF network element.

In some embodiments, the subscription data includes at least one of: a PEMC allowed indication and a PEGC allowed indication.

For the meanings and implementable forms of the above-mentioned PEMC allowed indication and PEGC allowed indication, reference may be made to the detailed descriptions of other embodiments in the disclosure, and details are not repeated herein.

In some embodiments, the UDM may actively send the subscription data to the AMF after determining the subscription data associated with the terminal.

Alternatively, the UDM may send the subscription data to the AMF after a sending condition is met. The sending condition may be a preset time interval, or a trigger from another device, etc., which is not limited in the disclosure.

This embodiment or any step in this embodiment may be combined with other embodiments arbitrarily without conflict, and may be combined with optional embodiments in other embodiments. The order of the steps in the combination may be interchanged without conflict. The optional embodiments in this embodiment may also be combined with other embodiments in the disclosure or with optional embodiments in other embodiments arbitrarily without conflict.

In the embodiment of the disclosure, the UDM sends the subscription data associated with the terminal to the AMF to assist the AMF in determining whether to accept a registration request of the terminal.

FIG. 12 is a schematic flowchart of a method for registering a PINE according to another embodiment of the disclosure. This method is executed by a UDM network element. As shown in FIG. 12, the method may include, but is not limited to, the following steps.

At step 1201: a subscription data acquisition request sent by an AMF network element is received, in which the subscription data acquisition request comprises an ID of the terminal.

At step 1201: subscription data associated with a terminal is sent to the AMF network element.

In some embodiments, the subscription data includes at least one of: a PEMC allowed indication and a PEGC allowed indication.

For the meanings and implementable forms of the aforementioned PEMC allowed indication and PEGC allowed indication, reference may be made to the detailed descriptions in other embodiments of the disclosure, and details will not be repeated here.

In some embodiments, in a case where the UDM receives the subscription request sent by the AMF, but does not contain the subscription data of the terminal, the UDM may also send empty subscription data to the AMF network element.

This embodiment or any step therein may be arbitrarily combined with other embodiments without conflict, and may also be combined with optional embodiments in other embodiments. The order of steps in the combination may be interchanged without conflict. The optional embodiments in this embodiment may also be arbitrarily combined with other embodiments of the disclosure or with optional embodiments in other embodiments without conflict.

In the embodiment of the disclosure, after receiving the subscription data acquisition request sent by the AMF, the UDM may send the subscription data associated with the terminal to the AMF, thereby providing an auxiliary condition for a registration process of the terminal.

To facilitate understanding of a method for registering a PINE of the disclosure, further explanation will be provided below in conjunction with the embodiment shown in FIG. 13. FIG. 13 is an interaction schematic diagram of a method for registering a PINE according to an embodiment of the disclosure.

According to the embodiment shown in FIG. 13, it assumes that: a UE (terminal) does not know its role (as PEGC, PEMC, or both) when sending a registration request, and the UE may or may not subscribe to a PIN service.

The method includes the following steps.

At step 1301, the UE sends a registration request to a gNB.

In some embodiments, the registration request includes a PIN capability indication, a PEGC capability, and/or a PEMC capability.

At step 1302, the gNB sends a registration request to an AMF.

This includes the PIN capability indication from step 1301.

At step 1303, the AMF sends a subscription data acquisition request to a UDM to obtain subscription data of the UE.

In some embodiments, the subscription data acquisition request may be Nudm_Get_SDM, which may include an ID of the terminal.

At step 1304, the UDM sends a Nudm_Get_SDM response to the AMF, including UE subscription data.

The subscription data may contain PIN information, for example, indicating the UE as the PEMC and/or the PEGC.

At step 1305, the AMF determines whether to accept the registration request based on the request from UE, and/or the UE subscription data from the UDM, and/or a preset policy, and/or capability information of a core network.

In a case where the network has a capability to support a PIN service, then the AMF accepts the registration request, including a PIN service supported indication.

When the PIN information provided by the UDM indicates that the UE is able to act as the PEGC and/or the PEMC, a registration accept message will include additional information, such as a PEGC allowed indication and/or a PEMC allowed indication.

At step 1306, the AMF sends a registration accept to the gNB.

It should be noted that if the AMF determines not to accept the registration request, the AMF will send a registration request rejection message to the gNB.

At step 1307, the gNB sends a registration accept message to the UE.

The aforementioned registration accept message may include the parameters carried in step 1305.

This embodiment or any step therein may be arbitrarily combined with other embodiments without conflict, and may also be combined with optional embodiments in other embodiments. The order of steps in the combination may be interchanged without conflict. The optional embodiments in this embodiment may also be arbitrarily combined with other embodiments of the disclosure or with optional embodiments in other embodiments without conflict.

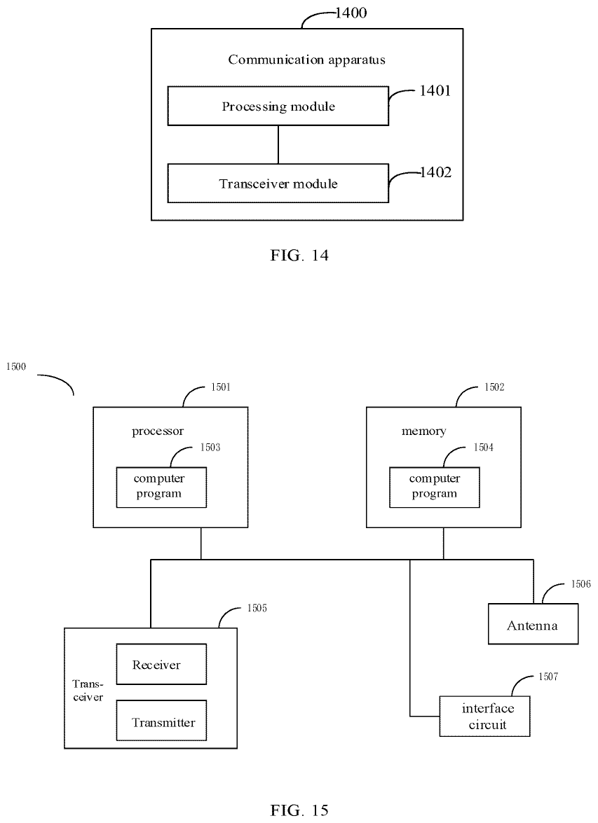

FIG. 14 is a schematic diagram of a communication apparatus provided by an embodiment of the disclosure. The communication apparatus 1400 shown in FIG. 14 may include a processing module 1401 and a transceiver module 1402. The transceiver module 1402 may include a sending module and/or a receiving module, in which the sending module is configured to implement a sending function, the receiving module is configured to implement a receiving function, and the transceiver module 1402 is able to implement both the sending and/or receiving functions.

It is able to be understood that the communication apparatus 1400 may be a terminal, an apparatus within a terminal, or an apparatus that may be used in conjunction with a terminal.

The communication apparatus 1400 is on a terminal side.

The transceiver module 1402 is configured to send a registration request to an access network device, in which the registration request includes PIN information of the terminal.

In some embodiments, the transceiver module 1402 is further configured to receive a registration response returned by the access network device.

In some embodiments, the PIN information includes at least one of: a PIN capability indication, a PEMC indication, and a PEGC indication.

In some embodiments, the registration response includes at least one of:
a PIN service supported indication, a PEMC allowed indication, or a PEGC allowed indication.

In the disclosure, the terminal may request registration with the core network by sending the registration request including its PIN information to the access network device, and determine whether the network accepts the registration request based on the registration response returned by the access network device. The terminal can register with the core network even without knowing its role in the PIN, and may also determine whether its registration request is accepted, so that the registration process is simple.

It may be understood that the communication apparatus 1400 may be an access network device, an apparatus within an access network device, or an apparatus that may be used in conjunction with an access network device.

The communication apparatus 1400 is on an access network device side.

The transceiver module 1402 is configured to receive a first registration request sent by a terminal, in which the first registration request includes PIN information of the terminal; and send a second registration request to an AMF network element, in which the second registration request includes the PIN information of the terminal.

In some embodiments, the transceiver module 1402 is further configured to:
receive a first registration response returned by the AMF network element; and
send a second registration response to the terminal.

The PIN information includes at least one of:
a PIN capability indication, a PEMC indication, or a PEGC indication.

In some embodiments, the first registration response and the second registration response include at least one of: a PIN service supported indication, a PEMC allowed indication, a PEGC allowed indication.

In the embodiments of the disclosure, during the registration process of the terminal, the access network device only needs to forward the registration request and registration response, resulting in low resource occupation of the access network device, a fast registration process, and high efficiency.

It may be understood that the communication apparatus 1400 may be an AMF network element, an apparatus within an AMF network element, or an apparatus that may be used in conjunction with an AMF network element.

The communication apparatus 1400 is on an AMF network element side.

The transceiver module 1402 is configured to receive a registration request sent by an access network device and/or receive subscription data associated with a terminal sent by a UDM network element, in which the registration request includes PIN information of the terminal;

The processing module 1401 is configured to determine whether to accept the registration request based on at least one of: the registration request, the subscription data, a preset policy, and capability information of the core network.

In some embodiments, the transceiver module 1402 is further configured to send a subscription data acquisition request to the UDM network element, in which the subscription data acquisition request includes an ID of the terminal.

In some embodiments, the transceiver module 1402 is further configured to send a registration response to the access network device.

In some embodiments, the PIN information includes at least one of:
a PIN capability indication, a PEMC indication information, or a PEGC indication information; and
the subscription data includes at least one of: a PEMC allowed indication, or a PEGC allowed indication.

In some embodiments, the registration response includes at least one of:
a PEMC allowed indication, or a PEGC allowed indication.

In some embodiments, the capability information of the core network indicates that the core network supports the PIN service, the registration response further includes a PIN service supported indication.

In the disclosure, after receiving the registration request of the terminal forwarded by the access network device, the AMF may send the subscription data acquisition request to the UDM. After acquiring the subscription data associated with the terminal, the AMF may determine whether to accept the registration request based on at least one of the registration request, the subscription data, the preset policy, or the capability information of the core network, and send the registration response to the access network device to synchronize the result of the registration request to the terminal. This registration process may be implemented without the terminal reporting its role in the PIN, with low resource occupation and a simple registration process.

It may be understood that the communication apparatus 1400 may be a UDM network element, an apparatus within a UDM network element, or, an apparatus that may be used in conjunction with a UDM network element.

The communication apparatus 1400 is on a UDM network element side.

The transceiver module 1402 is configured to send subscription data associated with a terminal to an AMF network element.

In some embodiments, the transceiver module 1402 is further configured to receive a subscription data acquisition request sent by the AMF network element, in which the subscription data acquisition request includes an ID of the terminal.

In some embodiments, the subscription data includes at least one of: a PEMC allowed indication, or a PEGC allowed indication.

In the embodiments of the disclosure, after receiving the subscription data acquisition request sent by the AMF, the UDM may send the subscription data associated with the terminal to the AMF, thereby providing auxiliary conditions for the registration process of the terminal.

FIG. 15 is a schematic diagram of a communication apparatus according to another embodiment of the disclosure. A communication apparatus 1500 may be a terminal, an access network device, an AMF network element, a UDM network element, or a chip, a chip system or a processor that supports the terminal to realize the above-described method, or a chip, a chip system or a processor that supports the access network device, the AMF network element, or the UDM network element to realize the above-described method. The apparatus is configured to realize the method in the above method embodiments with reference to the descriptions of the above-described method embodiments.

The communication apparatus 1500 may include one or more processors 1501. The processor 1501 may be a general purpose processor or a dedicated processor, such as, a baseband processor or a central processor. The baseband processor is configured for processing communication protocols and communication data. The central processor is configured for controlling communication apparatuses (e.g., base station, baseband chip, terminal, terminal chip, CU or DU), executing computer programs, and processing data of the computer programs.

In some embodiments, the communication apparatus 1500 may further include one or more memories 1502 on which a computer program 1504 may be stored. When the processor 1501 executes the computer program 1504, the communication apparatus 1500 is caused to perform the method in the above method embodiments. In some embodiments, data may also be stored in the memory 1502. The communication apparatus 1500 and the memory 1502 may be provided separately or may be integrated together.

In some embodiments, the communication apparatus 1500 may also include a transceiver 1505 and an antenna 1506. The transceiver 1505 may be referred to as transceiver unit, transceiver machine, or transceiver circuit, for realizing a transceiver function. The transceiver 1505 may include a receiver and a transmitter. The receiver may be referred to as receiver machine or receiving circuit, for realizing a receiving function. The transmitter may be referred to as transmitter machine or transmitting circuit, for realizing a transmitting function.

In some embodiments, the communication apparatus 1500 may also include one or more interface circuits 1507. The interface circuits 1507 are configured to receive code instructions and transmit the code instructions to the processor 1501. The processor 1501 runs the code instructions to cause the communication apparatus 1500 to perform the method in the method embodiments.

The transceiver 1505 in the communication apparatus 1500 may be configured to perform the sending/receiving steps in the above method embodiments.

In an implementation, the processor 1501 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be configured for code/data reading and writing, or may be configured for signal transmission or delivery.

In an implementation, the processor 1501 may store a computer program 1503 that may be run by the processor 1501 and may cause the communication apparatus 1500 to perform the method in the method embodiments above. The computer program 1503 may be solidified in the processor 1501, in which case the processor 1501 may be implemented by hardware.

In an implementation, the communication apparatus 1500 may include circuits. The circuits may implement the sending, receiving or communicating function in the preceding method embodiments. The processor and the transceiver in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the descriptions of the above embodiments may be an access network device, a terminal, an AMF network element or a UDM network element, but the scope of the communication apparatus in the disclosure is not limited thereto, and the structure of the communication apparatus may not be limited by FIG. 15. The communication apparatus may be a stand-alone device or may be part of a larger device. For example, the communication apparatus may be:
(1) a stand-alone IC, chip, chip system or subsystem;
(2) a collection of ICs including one or more ICs, in some embodiments, the collection of ICs may also include storage components for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

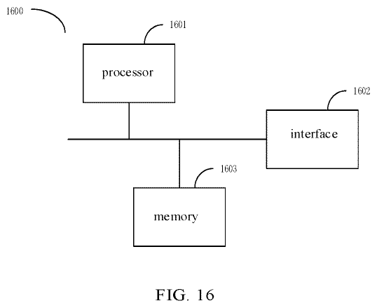

The case that the communication apparatus is a chip or a chip system can refer to the schematic diagram of the chip shown in FIG. 16. The chip shown in FIG. 16 includes a processor 1601 and an interface 1602. There may be one or more processors 1601, and there are multiple interfaces 1602.

The interface 1603 in the chip is configured to perform the sending/receiving steps in the above method embodiments.

In some embodiments, the chip further includes a memory 1603 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a non-transitory computer-readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions in the embodiments of the disclosure are implemented. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The non-transitory computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiment of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in the disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in the disclosure may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

1. A method for registering a personal internet of things network (PIN) element (PINE), performed by a terminal, comprising:
sending a registration request to an access network device, wherein the registration request comprises PIN information of the terminal.

2. The method according to claim 1, wherein after sending the registration request to the access network device, the method further comprises:
receiving a registration response returned by the access network device.

3. The method according to claim 1, wherein the PIN information comprises at least one of: a PIN capability indication, a PINE with management capability (PEMC) indication, or a PINE with gateway capability (PEGC) indication.

4. The method according to claim 2, wherein the registration response comprises at least one of: a PIN service supported indication, a PEMC allowed indication, or a PEGC allowed indication.

5. A method for registering a personal internet of things network (PIN) element (PINE), performed by an access network device, comprising:
receiving a first registration request sent by a terminal, wherein the first registration request comprises PIN information of the terminal; and
sending a second registration request to an access and mobility management function (AMF) network element, wherein the second registration request comprises the PIN information of the terminal.

6. The method according to claim 5, wherein after sending the second registration request to the AMF network element, the method further comprises:
receiving a first registration response returned by the AMF network element; and
sending a second registration response to the terminal.

7. The method according to claim 5, wherein the PIN information comprises at least one of: a PIN capability indication, a PINE with management capability (PEMC) indication, or a PINE with gateway capability (PEGC) indication.

8. The method according to claim 6, wherein each of the first registration response and the second registration response comprises at least one of:
a PIN service supported indication, a PEMC allowed indication, or a PEGC allowed indication.

9. A method for registering a personal internet of things network (PIN) element (PINE), performed by an access and mobility management function (AMF) network element, comprising at least one of:
receiving a registration request sent by an access network device, and/or receiving subscription data associated with a terminal sent by a unified data management (UDM) network element, wherein the registration request comprises PIN information of the terminal; and
the method further comprising determining whether to accept the registration request based on at least one of: the registration request, the subscription data, a preset policy, or capability information of a core network.

10. The method according to claim 9, wherein before receiving the subscription data associated with the terminal sent by the UDM network element, the method further comprises:
sending a subscription data acquisition request to the UDM network element, wherein the subscription data acquisition request comprises an identity (ID) of the terminal.

11. The method according to claim 9, wherein after determining whether to accept the registration request, the method further comprises:
sending a registration response to the access network device.

12. The method according to claim 9, wherein the PIN information comprises at least one of:
a PIN capability indication, a PINE with management capability (PEMC) indication, or a PINE with gateway capability (PEGC) indication; and
wherein the subscription data comprises at least one of: a PEMC allowed indication or a PEGC allowed indication.

13. The method according to claim 11, wherein the registration response comprises at least one of:
a PEMC allowed indication or a PEGC allowed indication.

14. The method according to claim 13, wherein the capability information of the core network indicates a capability of the core network to support a PIN service, and the registration response further comprises a PIN service supported indication.

15-21. (canceled)

22. A communication apparatus, comprising a processor and a memory for storing a computer program, wherein the processor executes the computer program stored in the memory to enable the communication apparatus to perform the method according to claim 1.

23. (canceled)

24. A non-transitory computer-readable storage medium for storing instructions that, when executed, enable the method according to claim 1 to be implemented.

25. A communication apparatus, comprising a processor and a memory for storing a computer program, wherein the processor executes the computer program stored in the memory to enable the communication apparatus to perform the method according to claim 5.

26. A communication apparatus, comprising a processor and a memory for storing a computer program, wherein the processor executes the computer program stored in the memory to enable the communication apparatus to perform the method according to claim 9.

27. A non-transitory computer-readable storage medium for storing instructions that, when executed, enable the method according to claim 5 to be implemented.

28. A non-transitory computer-readable storage medium for storing instructions that, when executed, enable the method according to claim 9 to be implemented.
